(19) United States
(12) Patent Application Publication
(10) Pub. No.: US 2017/0260977 A1
(43) Pub. Date: Sep. 14, 2017

(54) POSITIVE DISPLACEMENT LACT PUMP METERING

(71) Applicant: Ecolab USA Inc., St. Paul, MN (US)

(72) Inventor: Richard Lee Binks, Casper, WY (US)

(21) Appl. No.: 15/458,815

(22) Filed: Mar. 14, 2017

Related U.S. Application Data
(60) Provisional application No. 62/308,047, filed on Mar. 14, 2016.

(51) Int. Cl. F04B 49/06; F04B 1/12; G01F 1/84; F04B 17/03; F04B 19/22; F04B 51/00; F04B 1/16; F04B 11/00

(52) U.S. Cl. CPC F04B 49/065; F04B 1/16; F04B 1/128; F04B 11/0041; F04B 17/03; F04B 19/22; F04B 51/00; G01F 1/84

(57) ABSTRACT

A lease automatic custody transfer (LACT) system includes a pump assembly and meter system. The pump assembly is configured to pump a volume of fluid out of a storage container into a conduit. The pump assembly causes a pulsating flow of the volume of fluid through the conduit. The meter system is coupled to the conduit and includes a meter device and a processing system. The meter device is configured to obtain a plurality of measurements corresponding to the volume of fluid flowing through the conduit. The processing system is communicatively coupled to the meter device and configured to determine a flow parameter value based on the plurality of measurements.

### CROSS-REFERENCE TO RELATED APPLICATIONS

This application claims priority to and the benefit of U.S. Provisional Patent Applications Ser. No. 62/308,047, filed Mar. 14, 2016, entitled, “PROGRESSIVE TANK SYSTEM AND METHOD FOR USING THE SAME,” the disclosure of which is hereby incorporated by reference.

### BACKGROUND

Lease Automatic Custody Transfer (LACT) refers to the transportation of petroleum products from one entity to another entity. Pumping systems used in LACT are subject to various regulations and testing in order to ensure that the fluid pumped is accurately measured.

To ensure accurate measurement, current pumping systems used in (LACT) systems typically utilize centrifugal, gear, or progressive cavity pumps. These pumps provide laminar flow, which may allow for accurate and repeatable flow measure by conventional flow metering devices; however, these types of laminar flow pumps do not offer the efficient high pressure capabilities offered by positive displacement pumps, which provide a pulsating fluid flow.

Accordingly, it remains desirous to develop a pumping system that allows fluid to be pumped at higher pressure and flow while allowing accurate measurement of the system.

It is with respect to these and other considerations that the technology is disclosed. Also, although relatively specific problems have been discussed, it should be understood that the embodiments presented should not be limited to solving the specific problems identified in the introduction.

### SUMMARY

Aspects of the technology include a pumping system operatively coupled to a meter system such that the flow rate of the pumping system may be sampled at a sufficiently high frequency to account for non-constant (or pulsating) flow rate. For example, a higher-pressure pump, such as a positive displacement pump capable of running at flow pressure, may be coupled to a metering system capable of accounting for the variable flow and pressure caused by a positive displacement pump. For example, the meter system may be configured to obtain measurements of the fluid flow at a high sampling rate so as to determine fluid flow parameters, while minimizing any adverse effects on the calculation produced by the pulsation of the fluid flow induced by the positive displacement pump.

In particular, aspects of the technology aid in accurately capturing highly variable flow rates, which highly variable flowrates may be caused by the use of certain types of pumps (e.g., positive displacement pumps). For example, the use of positive displacement pumps may cause the flowrate of fluid through a system to oscillate rapidly between peak and trough velocities. In certain applications, such as LACT applications, the inability to capture the actual flowrate through each oscillation causes the LACT operation to fail. Such failure may occur because a master meter (which is used to ensure the pump meets regulatory requirements, in some applications) will read a different flow rate at a certain time than the pump meter at that time. Thus, having a pump meter that is capable of sampling at a high frequency may allow the data from the master meter to match the meter of the pump.

In aspects, the pumping system and meter system may be use as part of a LACT system. Additionally, the meter system includes a meter device operatively coupled to a processing system.

In an Example 1, LACT system comprises a pump assembly configured to pump a volume of fluid out of a storage container into a conduit, wherein the pump assembly causes a pulsating flow of the volume of fluid through the conduit; and a meter system coupled to the conduit, the meter system comprising: a meter device configured to obtain a plurality of measurements corresponding to the volume of fluid flowing through the conduit during each pulse; and a processing system communicatively coupled to the meter device and configured to determine a flow parameter value based on the plurality of measurements.

In an Example 2, the system of Example 1, wherein the pump assembly comprises a positive displacement pump.

In an Example 3, the system of any of Examples 1 and 2, wherein the pump assembly comprises a reciprocating positive displacement pump.

In an Example 4, the system of any of Examples 1 through 3, wherein the pump assembly comprises an internal pinion piston pump.

In an Example 5, the system of Example 4, wherein the internal pinion piston pump comprises a horizontal triplex piston pump.

In an Example 6, the system of any of Examples 2 through 5, wherein the pump assembly comprises an electric drive motor coupled to the pump, and an indexing sleeve extending between the electric drive motor and the pump to align a rotating drive shaft of the electric drive motor with a rotating drive shaft of the pump.

In an Example 7, the system of any of Examples 3 through 6, the pump comprising an oversized entrance header configured to add suction volume.

In an Example 8, the system of any of Examples 1 through 7, further comprising a suction pulsation stabilizer in fluid communication with the pump and configured to absorb at least a portion of the pressure variations of the pulsations of the fluid flow.

In an Example 9, the system of any of Examples 1 through 8, further comprising a dampener coupled to the conduit and configured to dampen the pulsations of the fluid flow.

In an Example 10, the system of any of Examples 1 through 9, the meter device comprising a Coriolis (mass) type flow meter.

In an Example 11, the system of any of Examples 1 through 9, the meter device comprising a bent tube meter.

In an Example 12, the system of any of Examples 1 through 9, the meter device comprising a straight tube meter.

In an Example 13, the system of any of Examples 1 through 12, wherein the meter system is configured to obtain between one hundred and six thousand samples per second.

In an Example 14, the system of Example 13, wherein the meter system is configured to obtain between one thousand and six thousand samples per second.

In an Example 15, the system of Example 14, wherein the meter system is configured to obtain five thousand samples per second.

In an Example 16, the system of any of Examples 1 through 15, wherein the meter system comprises a mechanical band pass filter configured to remove at least a portion of a signal corresponding to vibrations.

In an Example 17, the system of any of Examples 1 through 16, wherein the processing system comprises a processor coupled to the meter device and configured to (1) receive the plurality of measurements; and (2) determine the flow parameter value.

In an Example 18, the system of Example 17, wherein the processor is integrated with the meter device.

In an Example 19, the system of Example 17, wherein the processor is disposed in a computing device that is communicatively coupled to the meter device, the computing device comprising at least one of a laptop, a tablet, a desktop computer, programmable logic controller (PLC) and a mobile device.

In an Example 20, a method of providing a metered supply of a volume of fluid from a storage container to a conduit comprises: removing, using a pump assembly, a volume of fluid from a storage container; providing, using the pump assembly, the volume of fluid through a conduit, wherein providing the volume of fluid comprises causing a pulsating flow of the volume of fluid through the conduit; obtaining, using a meter system, a plurality of measurements corresponding to the volume of fluid flowing through the conduit; and determining, using the meter system, volume of flow based on the plurality of measurements.

In an Example 21, the method of Example 20, wherein the pump assembly comprises a positive displacement pump.

In an Example 22, the method of any of Examples 20 and 21, wherein the pump assembly comprises a reciprocating positive displacement pump.

In an Example 23, the method of any of Examples 20 through 22, wherein the pump assembly comprises an internal pinion piston pump.

In an Example 24, the method of Example 23, wherein the internal pinion piston pump comprises a horizontal triplex piston pump.

In an Example 25, the method of any of Examples 21 through 24, wherein the pump assembly comprises an electric drive motor coupled to the pump.

In an Example 26, the method of any of Examples 22 through 25, the pump comprising an oversized entrance header configured to add suction volume.

In an Example 27, the method of any of Examples 20 through 26, further comprising absorbing, using a suction pulsation stabilizer, at least a portion of the pressure variations of the pulsations of the fluid flow.

In an Example 28, the method of any of Examples 20 through 27, further comprising dampening, using a dampener, the pulsations of the fluid flow.

In an Example 29, the method of any of Examples 20 through 28, the meter device comprising a Coriolis flow meter.

In an Example 30, the method of any of Examples 20 through 28, the meter device comprising a bent tube meter.

In an Example 31, the method of any of Examples 20 through 28, the meter device comprising a straight tube meter.

In an Example 32, the method of any of Examples 20 through 31, wherein obtaining the plurality of measurements comprises obtaining between one hundred and six thousand samples per second.

In an Example 33, the method of Example 32, wherein obtaining the plurality of measurements comprises obtaining between one thousand and six thousand samples per second.

In an Example 34, the method of Example 33, wherein obtaining the plurality of measurements comprises obtaining five thousand samples per second.

In an Example 35, the method of any of Examples 20 through 34, further comprising removing, using a mechanical band pass filter, at least a portion of a signal corresponding to vibrations.

In an Example 36, method of any of Examples 20 through 35, wherein the pump assembly and meter system are components of a lease automatic custody transfer (LACT) system.

In an Example 37, a method of using a lease automatic custody transfer (LACT) system to provide a metered supply of a volume of oil from a storage container to a conduit comprises: transporting, using a pump assembly, a volume of oil from a storage container, the pump assembly comprising an electric drive motor coupled to an internal pinion piston pump, wherein the electric drive motor is configured to drive the pump to facilitate variable rate oil transfer; providing, using the pump assembly, the volume of fluid through a conduit, wherein providing the volume of fluid comprises causing a pulsating flow of the volume of fluid through the conduit; obtaining, using a meter device, a plurality of measurements corresponding to the volume of fluid flowing through the conduit, the meter device comprising a bent-tube mass flow meter; and determining, using a processing system communicatively coupled to the meter device, a mass flow rate based on the plurality of measurements.

### BRIEF DESCRIPTION OF THE DRAWINGS

FIG. 1 is a perspective view of an LACT system, in accordance with embodiments of the disclosure.

FIG. 2 is a perspective view of an LACT system, in accordance with embodiments of the disclosure.

FIGS. 3A and 3B are perspective views of a pump, in accordance with embodiments of the disclosure.

FIG. 3C is a section view of the pump shown in FIGS. 3A and 3B, in accordance with embodiments of the disclosure.

FIG. 4 is a perspective view of a pump, in accordance with embodiments of the disclosure.

FIG. 5 is a block diagram depicting an illustrative operating environment, in accordance with embodiments of the disclosure.

FIG. 6 is a block diagram depicting an illustrative computing device, in accordance with embodiments of the disclosure.

FIG. 7 is a flow diagram depicting an illustrative method of providing a metered supply of a volume of fluid from a storage container to a conduit, in accordance with embodiments of the disclosure.

FIG. 8 illustrates an example triplex pump velocity curve for one crankshaft revolution.

While the subject matter disclosed herein is amenable to various modifications and alternative forms, specific embodiments have been shown by way of example in the drawings and are described in detail below. The disclosed subject matter, however, is not limited to the particular embodiments described. On the contrary, the disclosure is intended to cover all modifications, equivalents, and alternatives falling within the ambit of the subject matter disclosed herein, as defined by the appended claims.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

The present disclosure relates to pumping systems, which pumping systems may be used in Lease Automatic Custody Transfer (LACT) systems. Conventionally, LACT pumping systems use low flow pumping systems such as centrifugal, gear, or progressive cavity pumps. This is done to provide repeatable, laminar flow. The laminar flow may provide acceptable accuracy in measuring flow rates, but the current metering/pumping systems are incapable of being used at high pressures and/or flow rates. The lower pressures/flow rates prolongs pumping, adds expense, and is unsuitable for certain applications. The present technology provides systems, methods, and devices that provide acceptable accuracy during high flow/pressure applications, such as pumps that cause pulsating flow.

By using a positive displacement pump and meter system configured to sample volume, flow, pressure, and/or mass at a high frequency during pumping, embodiments of the disclosure facilitate may facilitate more efficient LACT operations. For example, positive displacement pumps may facilitate higher efficiency, more reliable longevity, smaller environmental footprint, lower capital investment, and may include a piston and wiper with a ceramic liner that may eliminate the burdensome older technology of a plunger/packing arrangement.

In embodiments, a positive displacement pump assembly includes an electric drive motor and rigid machined coupling arrangement connected to an internal pinion piston pump, allowing it to be placed into variable rate/speed oil transfer duty service under the control of automated flow metering, and/or at a point of sale. This custom designed pump may include custom-configured components including but not limited to valves, piston assembly, the internal oil system, paint color, and a modified electric motor connection spool specific to LACT application. By using the conventional and reliable advantages of positive displacement pumps with an internal gear reduction versus current industry practices of meshed gears or progressive cavity designs, embodiments facilitate improved flow rates, efficiency, high turn down ratios and accuracy of metering.

Additionally, embodiments include a meter system that includes a meter device capable of obtaining fluid flow, volume, mass, and/or pressure measurements at a high sample rate (e.g., between approximately twenty and ten thousands samples per second) coupled with a processing system that is configured to process the samples to determine a flow parameter (e.g., flow rate, volume, mass, and/or pressure). The high sample rate allows for, in some embodiments, close tracking of changes in flow rates due to pulses during a positive displacement pump's operation.

Using a conventional mass (e.g., Coriolis) flow measurement with pulsating flow may be disadvantageous. The flow rate determined by such a meter is an instant value, so if the pulses do exist, the measurement will vary with the pulse, and since the output signal, (typically a 4-20 milliamp signal) is one instance of a series of measurements, pulsing flow could affect accuracy depending upon the signal response relationship to the flow variation. In embodiments, a slow moving piston/diaphragm style metering pump with a bent tube Coriolis meter may be useful provided that these pulses are dampened with electronic pressure compensation. That is, a faster response time setting may be used for pulsating flow, but, in embodiments, this can degrade the “responsiveness” of the flow measurement. In addition, pressure surges may add stress to the measurement tube(s), and a ‘thin’ walled bent tube meter allows the Bourdon Tube effect which influences (accuracy) measurement.

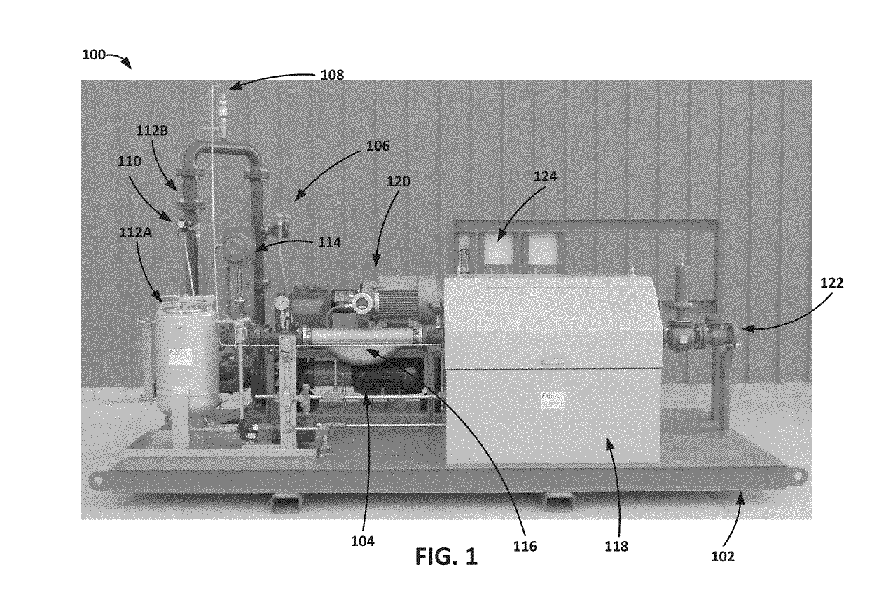

FIG. 1 is a perspective view an LACT system 100, in accordance with embodiments of the disclosure. The LACT system 100 can connect to a storage tank and pump and measure a volume of oil or other fluid removed from the storage tank. In some embodiments, the system is supported by a base assembly 102 that can be transported to remote locations and skid loaded to and from trucks or railcars. The base assembly 102 supports various components of the LACT system. A charge pump 104 assists with directing oil from a storage tank to the LACT system. In certain embodiments, the charge pump 104 causes a pulsating flow of the volume of oil. The charge pump 104 may include a positive displacement pump like a reciprocating positive displacement pump, internal pinion piston pump, and horizontal triplex piston pump.

In aspects of the technology, oil is then directed to a basic sediment and water (BS&W) probe 106 that monitors quality of incoming oil. For example, the probe 106 may measure water content of oil by determining dielectric constants of oil that vary with varying water content. A gas release device 108 is positioned at an upper elevation of the LACT system to permit gases to release from incoming oil and extinguish through the release device 108. A sample probe 110 may be used to extract samples from the oil and direct samples to a sample container 112A for testing characteristics of incoming oil. A static mixer 112B may be positioned upstream of the sample probe 110 and configured to ensure a sample that is at least approximately uniform and representative of the bulk fluid stream.

A three-way divert valve 114 may be configured to a default position that directs away from being measured and therefore away from entering the pipeline. The divert valve 114 may switch positions once incoming oil has passed through the BS&W probe 106 and determined to be of acceptable quality. A flow meter 116 such as a Coriolis meter, bent tube meter, or straight tube meter measures a volume of oil passing though the flow meter 116 and towards the pipeline. The metered oil can be directed to a prover loop 118, which assists with calibrating the flow meter 116. Oil can then be directed to a pipeline pump 120 that pumps metered, acceptable oil towards a discharge valve where oil exits the LACT system 100. In certain embodiments, the pipeline pump 120 causes a pulsating flow of the volume of oil. The pipeline pump 120 could include a positive displacement pump like a reciprocating positive displacement pump, for example internal pinion piston pump, or horizontal triplex piston pump.

In aspects of the technology, the flow meter 116 is configured to sample the flow, mass, volume, and or pressure at a high frequency. For example, a sampling frequency may be between 40 and 5000 cycles per second.

The various pumps, probes, valves, and meters of the LACT system can be fluidly coupled to each other either directly or through conduits extending between the various components. Moreover, the LACT system's various components can be coupled to a controller board 124 that processes, monitors, displays, and controls various aspects of the LACT system 100. For example, the controller board may display current readings of the BS&W probe. It will be appreciated that other devices and combinations of devices can process, monitor, display, and control the LACT system like laptops, tablets, desktop computers, mobile devices, and programmable logic controllers.

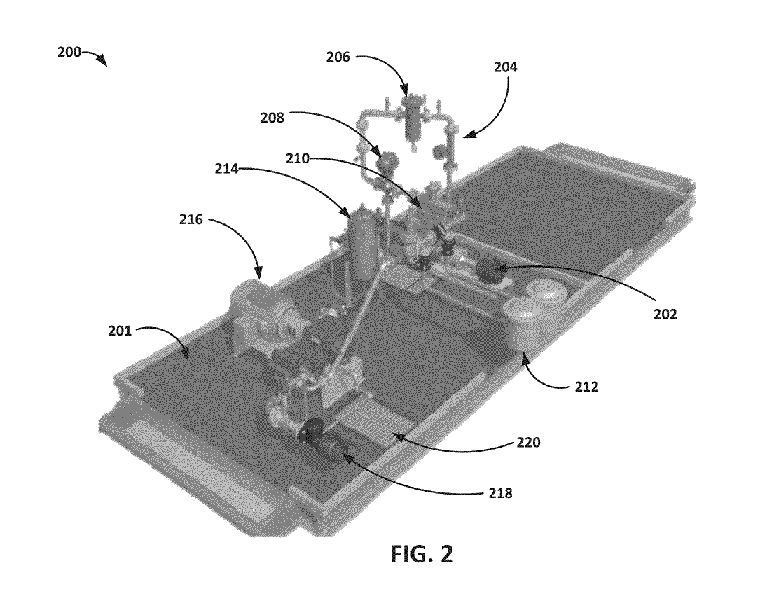

FIG. 2 is a perspective view of a LACT system 200, in accordance with certain embodiments of the disclosure. The LACT system 200 may be disposed on a skid 201 and includes a charge pump 202 that draws fluid oil from a storage tank (not shown) to the LACT system 200. The fluid is directed to a BS&W probe 204 that monitors water content, among other things, of the incoming fluid. A basket strainer 206 filters out dirt and other contaminants from the fluid. A divert valve 208 may direct fluid away from entering the pipeline if the fluid is determined to have unacceptable qualities. If the fluid is acceptable, the valve directs fluid to a flow meter 210.

The meter 210, such as a Coriolis meter, bent tube meter, or straight tube meter determines parameters relating to fluid flow during operation of system 200. In aspects, the meter 210 may determine flow by sampling at a significantly high rate, such as 40 to 5000 cycles per second.

Once metered, fluid may enter a prover loop 212, which assists with calibrating the flow meter 210. A sampling system 214 may be coupled to one of the conduits of the LACT system 200 to draw samples of fluid for testing. The metered and proven fluid is pumped by a high pressure pipeline pump 216 towards an outlet valve 218 so that the fluid can exit the LACT system 200 and enter the pipeline. In certain embodiments, the pipeline pump 216 causes a pulsating flow of the fluid and can be a positive displacement pump like a reciprocating positive displacement pump, internal pinion piston pump, and horizontal triplex piston pump. One or more sump pumps 220 may be included in the skid 201 to facilitate removing spilled fluids, accumulating precipitation, and/or the like.

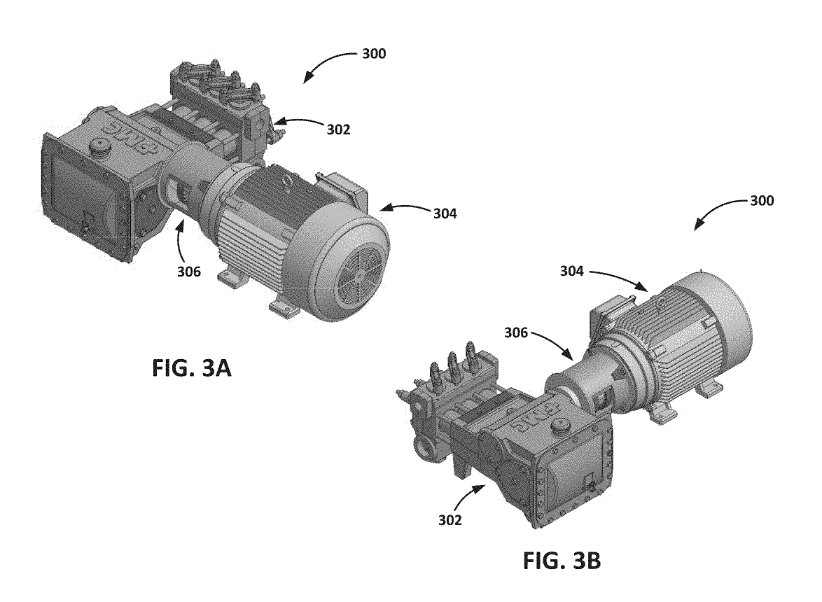

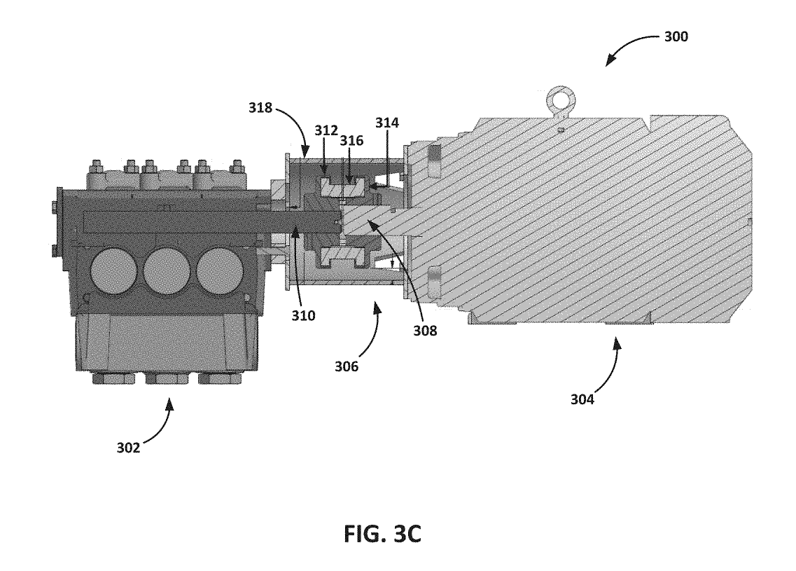

FIGS. 3A-3C depict various views of a pump assembly 300 in accordance with embodiments of the disclosure. The pump assembly 300 may be, include, or be included in, the pipeline pump 120 depicted in FIG. 1 and/or the pipeline pump 216 depicted in FIG. 2. As illustrated, the pump assembly 300 may include a positive displacement pump 302 driven by an electric motor 304. A drive assembly 306 is disposed between the pump 302 and the motor 304 and is configured to transfer power from the motor 304 to the pump 302. The pump 302 may be any number of different types of positive displacement pumps, as described herein. In embodiments, the pump 302 may be a triplex piston pump such as, for example, an L1118, available from FMC Technologies™, of Houston, Tex.

As shown in FIG. 3C, the drive assembly 306 may include a motor drive shaft 308 that is coupled to a pump drive shaft 310. The motor drive shaft 308 is rotationally driven by the electric motor 304 and is configured to transfer the rotation to the pump drive shaft 310, thereby operating the pump 302. A pump coupling flange 312 surrounds the end of the pump drive shaft, and a motor coupling flange 314 surrounds the end of the motor drive shaft 308. A coupling sleeve 316 is disposed between the coupling flanges 312 and 314, such that the drive shafts 308 and 310 are able to rotate. An indexing sleeve 318 is coupled, at a first end, to a housing of the pump 302 and at a second end to the housing of the motor 304, and extends between the two housings so as to maintain the drive shafts 308 and 310 in alignment.

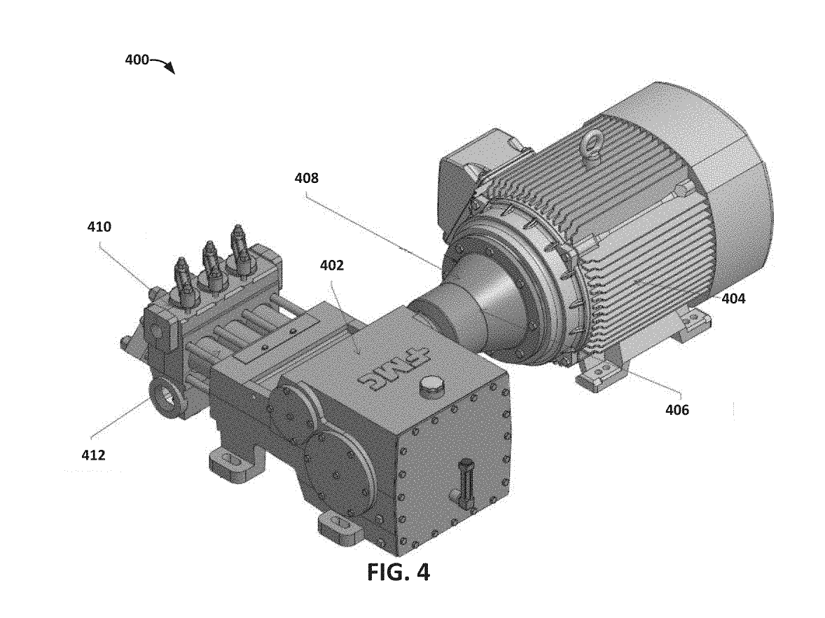

FIG. 4 is a perspective view of another pump assembly 400 in accordance with embodiments of the disclosure. The pump assembly 400 may be, include, or be included in, the pipeline pump 120 depicted in FIG. 1 and/or the pipeline pump 216 depicted in FIG. 2. As illustrated, the pump assembly 400 may include a positive displacement pump 402 driven by an electric motor 404. According to embodiments, the pump 402 may include an L1618 available from FMC Technologies, of Houston, Tex. A drive assembly 406 is disposed between the pump 402 and the motor 404 and is configured to transfer power from the motor 404 to the pump 402. As shown, the drive assembly 406 may include an indexing sleeve 408 (e.g., also referred to as an adapter flange) that may be configured to maintain alignment between the motor 404 and the pump 402, as described above with respect to a similar coupling sleeve 316 depicted in FIG. 3C. The pump may also include, in embodiments, a low NPSHr valve 410 design, and/or pistons assemblies 412 having pistons, wipers, and ceramic liners configured for use in the hydrocarbon industries. In aspects of the technology, the wipers are press formed hydrogenated nitrile butadiene rubber.

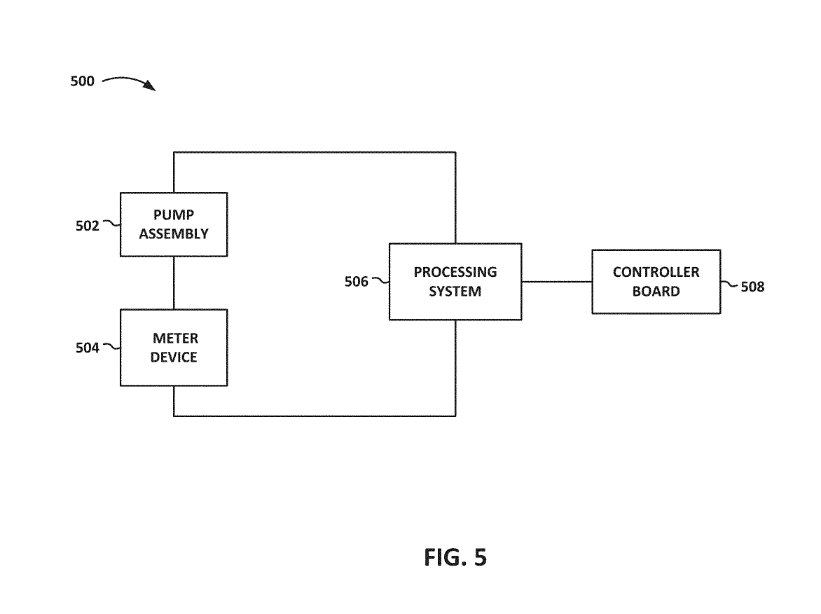

FIG. 5 is a block diagram depicting an illustrative operating environment 500 in accordance with embodiments of the disclosure. The operating environment may be, be associated with, include, or be included within an automatic custody transfer system such as, for example a Lease Automatic Custody Transfer (LACT) system (e.g., the LACT system 100 depicted in FIG. 1 and/or the LACT system 200 depicted in FIG. 2). As illustrated, the operating environment 500 includes a pump assembly 502, a meter device 504, a processing system 506, and a controller board 508.

The pump assembly 502 may include any pump assembly associated with a LACT system, as described herein, and may be, may be similar to, may include, or may be included in, for example, the charge pump 104 and/or the pipeline pump 120 depicted in FIG. 1, the charge pump 202 and/or the pipeline pump 216 depicted in FIG. 2, the pump assembly 300 depicted in FIGS. 3A-3C, and/or the pump assembly 400 depicted in FIG. 4. That is, for example, the pump assembly 502 may include a positive displacement pump that is driven by an electric motor. The pump assembly 502 may also include any number of different types of sensors that may be used to facilitate implementation of a control feedback loop and/or performance monitoring.

The meter device 504 may be part of a meter system that may also include the processing system 506, which may be configured to process measurement signals obtained by the meter device 504. The meter device 504 may include any number of different types of flow meters configured to obtain measurements corresponding to fluid movement through the pump assembly and/or a conduit coupled thereto. In embodiments, the meter device 504 may include a positive displacement meter, a turbine meter, a Coriolis meter, an ultrasonic meter, a bent tube meter, a curved tube meter, and/or the like. In embodiments, the meter device 504 may be, be similar to, include, or be included in the flow meter 116 depicted in FIG. 1, and/or the flow meter 210 depicted in FIG. 2.

In a meter system that may be implemented as part of the illustrative operating environment 500, the meter device 504 may be operatively (e.g., communicatively) coupled to the processing system 506. In embodiments, the processing system 506 may be operatively coupled to a number of different meter devices 504, which may be associated with different LACT systems. This connection (and any other connection contemplated between two or more components depicted in FIG. 5) may be wired, wireless, or a combination of these. The processing system 506 may be, include, or be included in one or more processors, programmable logic controllers (PLCs), electronic circuits, and/or the like, and may be implemented in a computing device (e.g., a laptop, a mobile device, a server, the controller board 508, and/or the like), integrated with the meter device 504, and/or the like. The processing system 506 may be implemented using hardware, software, firmware, and/or a combination of these.

According to embodiments, the processing system 506 may be configured to control the meter device 504 (e.g., to cause the meter device 504 to obtain measurements at certain times, at certain sampling rates, and/or the like), to process measurement signals obtained by the meter device 504 (e.g., measurements of values of a parameter corresponding to fluid flow), and to perform a task in response to the results of processing the measurement signals. That task may include, for example, causing a display device to present the results (e.g., a calculated flow rate), to control the pump assembly 502 (e.g., by adjusting, starting, and/or stopping the flow of fluid), and/or the like.

According to embodiments, the processing system 506 is configured to coordinate with the meter device 504 to obtain measurements at a high sampling rate to facilitate accurate flow measurements since the positive displacement pump induces a pulsed flow. The sampling rate may be, for example, between one hundred and six thousand samples per second. In embodiments, the sampling rate may be between one thousand and six thousand samples per second (e.g., five thousand samples per second, six thousand samples per second, etc.). Any number of different sampling rates may be used and may be adjusted based on one or more circumstances and/or conditions of the operation. In embodiments, the processing system 506 may be configured to dynamically adjust the sampling rate in response to any number of different conditions, optimizations, feedback control loops, and/or the like.

In embodiments, the processing system 506 may include and utilize electric components and/or software for performing digital signal processing on samples obtained from the meter device 504. For example, in embodiments, the processing system 506 may perform phase shifting, filtering, and/or the like. The meter system (e.g., the meter device 504 and processing system 506) may incorporate mechanical, electronic, and/or digital isolation techniques that eliminate or reduce stress and/or vibration from affecting measurements. For example, in embodiments, mechanical band pass filtering may be utilized where external influences due to vibrations are forced to be a lower frequency within the instrument housing, allowing the isolated measurement section to make the higher frequency measurement. Combined with the high sampling rates of the signal processing, and a one or more electronic filters, embodiments may facilitate more reliable measurement than current systems.

The processing system 506 may be configured to receive, and act in accordance with, input from a user and/or other device (e.g., via the controller board 508). It will be appreciated by individuals having skill in the relevant arts that the processing system 506 may be configured to implement pre-set capabilities, user-configurable inputs and outputs, bidirectional communications, security paradigms, event logging, transactions, automatic flow control, programmable valve control, and/or the like.

The controller board 508 may be, be similar to, include, or be included in any control panel, controlling computing device, control station, and/or the like, associated with one or more LACT systems, as described herein. In embodiments, the controller board 508 may include any number of different types of input devices and/or output devices. The processing system 506 may be disposed in, integrated with, and/or coupled to (e.g., physically and/or communicatively) the controller board 508. The controller board may include panel indicator lights, security components, manual controls, and/or the like, that enable a user to obtain information and/or control any number of various aspects of the illustrative operating environment 500. In embodiments, the controller board may be, be similar to, include, or be included in, the controller board 124 depicted in FIG. 1.

According to embodiments, one or more aspects of the operating environment 500 described herein may include any number of sensors, detectors, transducers, and/or the like that may be used to monitor and/or control operation of at least a portion of the operating environment 500. For example, such components may facilitate monitoring the fluid flow, fluid temperature, fluid pressure, viscosity and/or other fluid quality measures, device/component temperature, device/component pressure, and/or the like. Any number of various monitoring and/or control procedures may be performed using one or more computing devices, which may be local or remote, with respect to the operating environment 500.

The illustrative operating environment 500 shown in FIG. 5 is not intended to suggest any limitation as to the scope of use or functionality of embodiments of the present disclosure. Neither should the illustrative operating environment 500 be interpreted as having any dependency or requirement related to any single component or combination of components illustrated therein. Additionally, various components depicted in FIG. 5 may be, in embodiments, integrated with various ones of the other components depicted therein (and/or components not illustrated), all of which are considered to be within the ambit of the present disclosure.

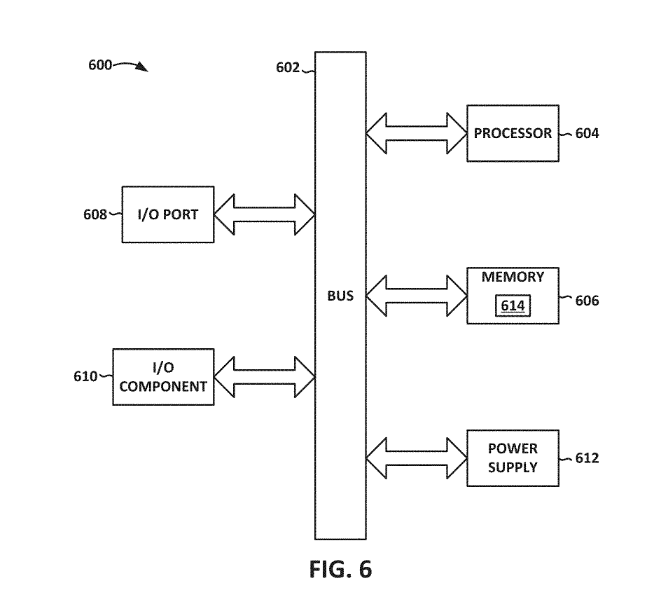

According to various embodiments of the disclosed subject matter, any number of the components depicted in FIG. 5 (e.g., aspects of the pump assembly 502, the meter device 504, the processing system 506, and/or the controller board 508) may be implemented on one or more computing devices. FIG. 6 is a block diagram depicting an illustrative computing device 600, in accordance with embodiments of the disclosure. The computing device 600 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIG. 5, with reference to various components of the operating environment 500 and/or computing device 600.

In embodiments, the computing device 600 includes a bus 602 that, directly and/or indirectly, couples the following devices: a processor 604, a memory 606, an input/output (I/O) port 608, an I/O component 610, and a power supply 612. Any number of additional components, different components, and/or combinations of components may also be included in the computing device 600. The I/O component 610 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 602 represents what may be one or more busses (such as, for example, an address bus, data bus, or combination thereof). Similarly, in embodiments, the computing device 600 may include a number of processors 604, a number of memory components 606, a number of I/O ports 608, a number of I/O components 610, and/or a number of power supplies 612. Additionally any number of these components, or combinations thereof, may be distributed and/or duplicated across a number of computing devices.

In embodiments, the memory 606 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 606 stores computer-executable instructions 614 for causing the processor 604 to implement aspects of embodiments of system components discussed herein and/or to perform aspects of embodiments of methods and procedures discussed herein.

The computer-executable instructions 614 may include, for example, computer code, machine-usable instructions, and the like such as, for example, program components capable of being executed by one or more processors 604 associated with the computing device 600. Program components may be programmed using any number of different programming environments, including various languages, development kits, frameworks, and/or the like. Some or all of the functionality contemplated herein may also, or alternatively, be implemented in hardware and/or firmware.

The illustrative computing device 600 shown in FIG. 6 is not intended to suggest any limitation as to the scope of use or functionality of embodiments of the present disclosure. Neither should the illustrative computing device 600 be interpreted as having any dependency or requirement related to any single component or combination of components illustrated therein. Additionally, various components depicted in FIG. 6 may be, in embodiments, integrated with various ones of the other components depicted therein (and/or components not illustrated), all of which are considered to be within the ambit of the present disclosure.

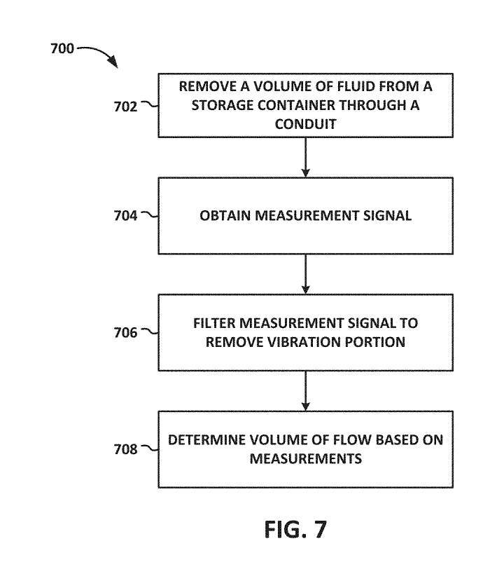

As described above, embodiments of the subject matter described herein may be used to provide a metered supply of a volume of fluid to a conduit. FIG. 7 is a flow diagram depicting an illustrative method 700 of providing a metered supply of a volume of fluid from a storage container to a conduit. Aspects of embodiments of the method 700 may be implemented by a system (e.g., the system 100 depicted in FIG. 1, the system 200 depicted in FIG. 2, and/or the operating environment depicted in FIG. 5) configured to provide a metered supply of a fluid. For example, the system may be a lease automatic custody transfer (LACT) system for use in an oil and/or gas field.

Embodiments of the method 700 include removing, using a pump assembly, a volume of fluid from a storage container (block 702). The pump assembly may be used, for example, for providing the volume of fluid through a conduit. According to embodiments, the pump assembly causes a pulsating flow of the volume of fluid through the conduit. For example, the pump assembly (e.g., the pump assembly 300 depicted in FIGS. 3A-3C, and/or the pump assembly 400 depicted in FIG. 4) may include a positive displacement pump such as, for example, a reciprocating positive displacement pump. The reciprocating positive displacement pump may be, for example, an internal pinion piston pump (e.g., a horizontal triplex piston pump). In embodiments, the pump assembly includes an electric drive motor coupled to, and configured to drive, the pump. In embodiments, the pump may include an oversized entrance header configured to add suction volume.

As shown in FIG. 7, embodiments of the method 700 include obtaining, using a meter system, a measurement signal (block 704). The measurement signal may include, for example, a number of measurements corresponding to the volume of fluid flowing through the conduit. In embodiments, the measurement signal may be obtained using a sample rate between one hundred and six thousand samples per second. In embodiments, the sample rate may be between one thousand and six thousand samples per second (e.g., five thousand samples per second). The meter device may include a Coriolis flow meter, a bent tube meter, a straight tube meter, a vortex meter, and/or the like.

According to embodiments, the method 700 may include filtering the measurement signal to remove a vibration portion (block 706), and determining, using the meter system, volume of flow based on the plurality of measurements (block 708). This may facilitate minimizing the influence of mechanical vibrations on the measurement signal. In embodiments, the filter may be, include, or be included in, a mechanical band pass filter, an electronic filter, a digital filter, and/or the like. According to embodiments, the method 700 may further include absorbing, using a suction pulsation stabilizer, at least a portion of the pressure variations of the pulsations of the fluid flow. In embodiments, a dampener may be used to dampen the pulsations of the fluid flow, and may be, include, or be included in, a mechanical dampener, an electronic dampener, a digital dampener, and/or the like. In embodiments, for example, digital signal processing (DSP) techniques may be used to adaptively dampen, flatten, or otherwise process the measurement signal to facilitate more reliably measuring fluid flow characteristics, account for the pulsating nature of the fluid flow, and/or the like.

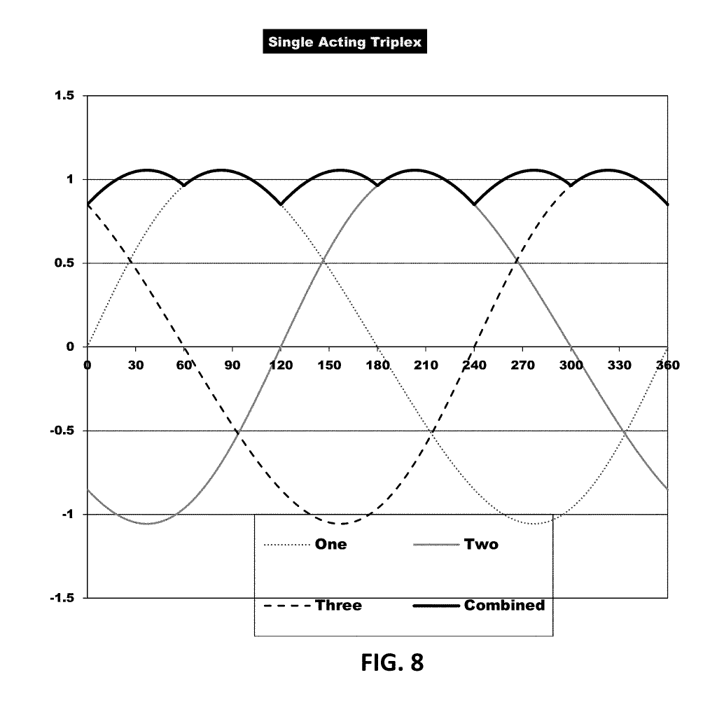

FIG. 8 illustrates an example triplex pump velocity curve for one crankshaft revolution. The y-axis 802 is the relative crankshaft position, with value 1.06 representing fully engaged crankshaft and −1.06 representing fully disengaged crankshaft. The x-axis 804 represents the relative time. In aspects, the value 360 of the x-axis corresponds to 0.2142 seconds (e.g., 280 rotations per minutes). FIG. 8 also indicates a first crank shaft rotation position 806, a second crankshaft position 808, and a third crankshaft position 810. The combined crankshaft position 812 is also illustrated.

It will be appreciated that, in aspects of the technology, the combined crankshaft position correlates to a flowrate of the triplex pump. As the combined crankshaft position 812 varies over the cycle of the pump rotation, the flowrate will similarly vary with time.

High-frequency flowrate measurements 814 are also illustrated. The high-frequency flowrate measurements 814 are represented by the squares. Each square of the high-frequency flowrate measurements 814 indicate a corresponding measurement of the flowrate. For a triplex operating at 280 rpms, the frequency of the illustrated high-frequency flowrate measurements 814 is around 4860 Hz. It will be appreciated that higher or lower frequencies are contemplated.

Additionally, a low frequency measurement 816 is illustrated. For a triplex operating at 280 rpms, the frequency of the illustrated low-frequency flowrate measurement 816 is around 320 Hz.

A comparison of measurements 814 and 816 reveals that the higher frequency measurements provide a more accurate profile of a triplex pump velocity curve, in aspects of the technology.

While embodiments of the subject matter disclosed herein are described with specificity, the description itself is not intended to limit the scope of this patent. Thus, the inventors have contemplated that the claimed subject matter might also be embodied in other ways, to include different steps or features, or combinations of steps or features similar to the ones described in this document, in conjunction with other technologies.

The following is claimed:

1. A lease automatic custody transfer (LACT) system, comprising:
a pump assembly configured to pump a volume of fluid out of a storage container into a conduit, wherein the pump assembly causes a pulsating flow of the volume of fluid through the conduit; and
a meter system coupled to the conduit, the meter system comprising:
a meter device configured to obtain a plurality of measurements corresponding to the volume of fluid flowing through the conduit, wherein the measurements are obtained at around 5000 times per second; and
a processing system communicatively coupled to the meter device and configured to determine a flow parameter value based on the plurality of measurements.

2. The system of claim 1, wherein the pump assembly comprises a positive displacement pump.

3. The system of any of claims 1, wherein the pump assembly comprises a reciprocating positive displacement pump.

4. The system of any of claims 1, wherein the pump assembly comprises an internal pinion piston pump.

5. The system of claim 4, wherein the internal pinion piston pump comprises a horizontal triplex piston pump.

6. The system of any of claims 2, wherein the pump assembly comprises an electric drive motor coupled to the pump, and an indexing sleeve extending between the electric drive motor and the pump to align a rotating drive shaft of the electric drive motor with a rotating drive shaft of the pump.

7. The system of any of claims 3, the pump comprising an oversized entrance header configured to add suction volume.

8. The system of any of claims 1, further comprising a suction pulsation stabilizer in fluid communication with the pump and configured to absorb at least a portion of the pressure variations of the pulsations of the fluid flow.

9. The system of any of claims 1, further comprising a dampener coupled to the conduit and configured to dampen the pulsations of the fluid flow.

10. The system of any of claims 1, the meter device comprising a Coriolis flow meter.

11. The system of any of claims 1, the meter device comprising a bent tube meter.

12. The system of any of claims 1, the meter device comprising a straight tube meter.

13. The system of any of claims 1, wherein the meter system is configured to obtain between one hundred and six thousand samples per second.

14. The system of claim 13, wherein the meter system is configured to obtain between one thousand and six thousand samples per second.

15. The system of claim 14, wherein the meter system is configured to obtain five thousand samples per second.

16. The system of any of claims 1, wherein the meter system comprises a mechanical band pass filter configured to remove at least a portion of a signal corresponding to vibrations.

17. A method of providing a metered supply of a volume of fluid from a storage container to a conduit, the method comprising:
removing, using a pump assembly, a volume of fluid from a storage container;
providing, using the pump assembly, the volume of fluid through a conduit, wherein providing the volume of fluid comprises causing a pulsating flow of the volume of fluid through the conduit;
obtaining, using a meter system, a plurality of measurements corresponding to the volume of fluid flowing through the conduit, wherein the meter system measures the plurality of measurements at a rate of between 35 and 5000 samples per second; and
determining, using the meter system, volume of flow based on the plurality of measurements.

18. The method of claim 17, wherein the pump assembly comprises a positive displacement pump.

19. The method of any of claims 18, wherein the pump assembly comprises a reciprocating positive displacement pump.

20. A method of using a lease automatic custody transfer (LACT) system to provide a metered supply of a volume of oil from a storage container to a conduit, the method comprising:
transporting, using a pump assembly, a volume of oil from a storage container, the pump assembly comprising an electric drive motor coupled to an internal pinion piston pump, wherein the electric drive motor is configured to drive the pump to facilitate variable rate oil transfer;
providing, using the pump assembly, the volume of fluid through a conduit, wherein providing the volume of fluid comprises causing a pulsating flow of the volume of fluid through the conduit;
obtaining, using a meter device, a plurality of measurements corresponding to the volume of fluid flowing through the conduit, the meter device comprising a bent-tube mass flow meter and configured to sample at a rate of between 1000 and 5000 cycles per second; and
determining, using a processing system communicatively coupled to the meter device, a mass flow rate based on the plurality of measurements.
